(19) United States
(12) Patent Application Publication
(10) Pub. No.: US 2014/0268673 A1
(43) Pub. Date: Sep. 18, 2014

(54) AQUA LAMP BASE WITH DYNAMICAL LIGHT EFFECT

(71) Applicant: CHIN-SHENG YANG, Tainan City (TW)

(72) Inventor: CHIN-SHENG YANG, Tainan City (TW)

(21) Appl. No.: 13/802,829

(22) Filed: Mar. 14, 2013

(51) Int. Cl. F21V 31/04; F21V 21/14

(52) U.S. Cl. CPC F21V 31/04; F21V 21/14
USPC 362/101

(57) ABSTRACT

The present application is related to an aqua lamp base with dynamical light effect, mainly comprising a base body, a projecting ring and a solid decoration. The base body is light transmissive and comprises a light-emitting element and a light transmissive rotary dish; the projecting ring comprises hollow patterns. The projecting ring is surroundingly set at the outer edge of the rotary dish, and circles the light-emitting element. The solid decoration is light transmissive and fixedly poisoned on the base body; thereby, the light source of the light-emitting element projects the patterns of the projecting ring onto the base body and the patterns show various dynamical light effects with the rotation of the rotary dish and allows the base body create spectacular visual effect when the projecting ring is driven by the rotary dish.

### (A) TECHNICAL FIELD OF THE INVENTION

The present invention generally relates to an aqua lamp base, and more particularly to an aqua lamp base design of object visual allocation in an environmental space to create a spectacular visual effect with the dynamical light effect from the base.

### (B) DESCRIPTION OF THE PRIOR ART

Generally in daily life, the table ornaments on the desk, such as picture frames, toy decorations and etc, are all artistic, ornamental, static state objects. Therefore, aqua lamps design with paillette, glitter powder or decoration inside presents. By manually putting upside down, manually shaking or flowing the paillette, the glitter powder or the decoration inside by electric power, the visual perception is created thereby. With different objects inside the aqua lamps, the different visual effect can be created. The reaching possibilities, the development of the various visual variations or multifunction, interesting can be provided with. Therefore, the aqua lamps design becomes an issue for the developer of the environment ornaments.

Accordingly, the inventor of the present invention designs and creates a combination of an electronic candle to allow the light source with plenteous visual effects and an aqua lamp with dynamically rotation effect. The artistic, ornamental and interesting conditions can be improved. With constant experiments and improvements, the present invention now can be created.

### SUMMARY OF THE INVENTION

The present invention is related to an aqua lamp base with dynamical light effect, mainly comprising:

a base body, being light transmissive and having an opening upward, and the base body comprises at least one light-emitting element inside and a light transmissive rotary dish drove and rotated by a power unit;

a projecting ring, being a light transmissive plate body with patterns, and the projecting ring is surroundingly set at the outer edge of the rotary dish, and circling the light-emitting element; and

a solid decoration, being light transmissive and fixedly poisoned on the base body.

Thereby, the light source of the light-emitting element projects the patterns of the projecting ring onto the base body and the patterns show various dynamical light effects with the rotation of the rotary dish and allows the base body to create spectacular visual effect when the projecting ring is driven by the rotary dish.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view diagram of the present invention.

FIG. 2 is a perspective diagram of the present invention.

FIG. 3 is a sectional diagram of the present invention.

FIG. 4 is a diagram of the light projection and reflection in the present invention.

FIG. 5 is a diagram of the working condition of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Please refer to FIG. 1 to FIG. 3, which are an exploded view diagram, a perspective diagram and a sectional diagram of the aqua lamp base with dynamical light effect according to the present invention. The aqua lamp base mainly comprises a base body 1, a projecting ring 2 and a solid decoration 3. The base body 1 is light transmissive and has an opening 11 upward. The base body 1 comprises two light-emitting elements 12 inside. The amount of the light-emitting elements 12 is not limited. In this embodiment, two light-emitting elements 12 are illustrated. The base body 1 further comprises a power circuit component 13 electrically connected to the light-emitting elements 12. Meanwhile, a switch 14 which is connected to a power source for generating power is located at one side of the base body 1. The switch 14 is electrically connected to the power circuit component 13 for controlling on and off of the light-emitting element 12. The power circuit component 13 is capable of controlling light color changes of the light-emitting element 12. The light-emitting elements 12 can be light emitting diodes. The base body 1 further comprises a power unit 15 to drive and rotate a light transmissive rotary dish 16. The power unit 15 comprises an upward extending rotary shaft 151. The light transmissive rotary dish 16 comprises a through hole 161 corresponding to the rotary shaft 151.

The projecting ring 2 is a light transmissive plate body with hollow patterns and preferably manufactured by plastic material. The projecting ring 2 is surroundingly set at the outer edge of the rotary dish 16 and circles the light-emitting element 12. Only patterns 21 of the projecting ring 2 are light transmissive and the rest areas are opaque, thereby, the light source of the light-emitting elements 12 project the patterns 21 onto the surface of the base body 1.

The solid decoration 3 is light transmissive and fixedly poisoned on the base body 1. In this embodiment, the appearance of an aqua ball is illustrated but not restriction to the present invention. The aqua ball can be a light transmissive stereo-configuration object which is filled up with flowable liquid. The aqua ball can be filled with paillette and glitter powder inside. Thereby, the light source of the light-emitting elements 12 project the patterns 21 of the projecting ring 2 onto the base body 1 and the patterns 21 shows various dynamical light effects with the rotation of the rotary dish 16 and allows the base body 1 create spectacular visual effect when the projecting ring 2 is driven by the rotary dish 16 inside the base body 1.

Furthermore, the projecting ring 2 and the rotary dish 16 can be in shape of one body. The projecting ring 2 can extend from the rotary dish 16. The areas except the patterns 21 are shielded and the light source can project the patterns 21 onto the base body 1. The method of shielding can be coating, attaching or other means. Therefore, the component assembly can be easier to decrease the accumulated tolerance of the assembly.

Moreover, the power unit 15 is controlled by the switch 14 and the power source can be assembled battery, or an alternating current/direct current supply. The power supply source can be possibly various and is not restricted in claims, the detail description is omitted hereby.

Please refer to FIG. 4 and FIG. 5, which are diagrams of projection of the light-emitting elements 12. Only the patterns 21 of the projecting ring 2 are light transmissive. Therefore, as the light source projects on the areas which are not patterned (indicated by arrows), the light is reflected and projects on the opposite surface. Accordingly, the projection of the patterns 21 of the base body 1 creates effect of superimposition images to allow the present invention to create multi-level, plenteous visual effects. The exterior of the base body 1 also can have decoration patterns 17 which can be attached or painted on the base body 1 to increase the variation thereof.

With the aforesaid embodiment of the present invention, several benefits are now concluded hereafter:

1. In the aqua lamp base with dynamical light effect, the base body 1 comprises light-emitting elements 12 inside and the projecting ring 2 is driven and rotated. The visual effect of the dynamical light can be created.

2. In the aqua lamp base with dynamical light effect, the projection and superimposition images are created with the light projection and reflection.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An aqua lamp base with dynamical light effect, mainly comprising:
a base body, being light transmissive and having an opening upward, and the base body comprises at least one light-emitting element inside and a light transmissive rotary dish drove and rotated by a power unit;
a projecting ring, being a light transmissive plate body with hollow patterns, and the projecting ring is surroundingly set at the outer edge of the rotary dish, and circling the light-emitting element; and
a solid decoration, being light transmissive and fixedly poisoned on the base body.

2. The aqua lamp base with dynamical light effect according to claim 1, wherein said base body comprises a power circuit component electrically connected to the light-emitting element, and a switch which is to connected to a power source for generating power is located at one side of the base body, and the switch is electrically connected to the power circuit component.

3. The aqua lamp base with dynamical light effect according to claim 2, wherein said power circuit component is capable of controlling light color changes of the light-emitting element.

4. The aqua lamp base with dynamical light effect according to claim 3, wherein said light-emitting element is a light emitting diode.
